(19) United States
(12) Patent Application Publication
(10) Pub. No.: US 2020/0098001 A1
(43) Pub. Date: Mar. 26, 2020

(54) SYSTEM AND METHOD FOR PERFORMANCE ANALYSIS OF ADVERTISEMENTS ACROSS MULTIPLE CHANNELS

(71) Applicant: RAKESH ANTALA, Old Bridge, NJ (US)

(72) Inventor: RAKESH ANTALA, Old Bridge, NJ (US)

(21) Appl. No.: 16/581,645

(22) Filed: Sep. 24, 2019

Related U.S. Application Data
(60) Provisional application No. 62/735,190, filed on Sep. 24, 2018.

(51) Int. Cl. G06Q 30/02

(52) U.S. Cl. CPC G06Q 30/0246; G06Q 30/0277; G06Q 30/0276; G06Q 30/0244

(57) ABSTRACT

The present invention is a system and a method for collecting advertising data, as well as real-time monitoring and analysis of advertising performance using mobile terminals and a network.

The present invention relates to a computerized and automated system and method for monitoring and analyzing performance of advertisement campaigns use a mobile device or a computer and network to communicate with a server and implement an advertisement campaign through the planning, execution, monitoring and analysis and tuning stages. The advertisement campaign operates a campaign with advertisements in different media and provides a common computerized user interface for each of the campaign stages.

This application claims priority of a provisional patent application No. 62/735,190, filed on Sep. 24, 2018, and entitled “System and Method for Performing Analysis of Advertisements Across Multiple Channels”.

### TECHNICAL FIELD

The present invention relates to a system and a method for collecting advertising data, as well as real-time monitoring and analysis of advertising performance using mobile terminals and a network. It also includes a system and method for rewarding consumers and their brand interactions.

### BACKGROUND

The present invention relates to a computerized and automated system and method for monitoring and analyzing performance of advertisements across various channels such as out of home, print, transit, ambient, cinema, radio using various matrix codes scanning, image/voice recognition, near field communication technologies and mobile terminals via network. The present invention relates to automated system and method for collecting information about consumer groups including but not limited to advertising media, advertising territory, demographics and consumer behavior.

### SUMMARY OF THE INVENTION

Currently, the advertising world, especially non-digital avenues are riddled with performance measurement issues. As a result, on-ground ad sales are going down and marketers are switching to digital venues. The present invention offers a simple but effective way to overcome these challenges.

One aspect of the present invention is that the information collected through the novel system and using the method of the invention could be classified according to media type, region, content, publisher and synchronized with data collected at the time of scanning, and it allows for real-time, comprehensive and accurate advertisement monitoring and analytics.

Another aspect of the present invention is that it may include a feature of rewarding consumers and their brand interaction. Advertising across non-digital channels such as out of home, print, radio, transit plays an integral part of any national or local campaign. Such advertisement channels are often cost effective, when compared to digital, and have very distinct value proposition in attracting marketers and businesses wishing to craft an integrated marketing strategy.

With advances in digital platforms and web advertising coupled with increasing access to the internet, people are using their devices increasingly to access all kinds of services from shopping to information gathering to buying and selling a product of service. In at least one embodiment of the present invention, the traditional on-ground advertising avenues like newspapers, magazines and smaller advertising displays may use the features of the present invention by including URLs in their advertisements that the target audience can use to access relevant web pages in real time, and gain more information about the particular products or services being advertised.

However, there are some wide gaps and missing elements in the non-digital advertising niche. One such problem is advertisers' inability to discover various options to advertise; plan and execute effective campaigns; assess, measure and track the performance of such marketing and advertising investments.

Digital advertisements like those offered by Google's AdWords or even paid ads on social networks like Facebook and LinkedIn offer definite algorithms for measuring return on investment using established, real-time analytics and data. In contrast, advertisers in the non-digital niche have been evaluating and analyzing advertising effects primarily by means of telephone feedbacks, sales statistics, questionnaire surveys, which typically get results several days—or even weeks after the advertisements are distributed. This is an inadequate solution for gathering and sharing real-time, dynamic and continuous analysis reports.

Another challenge with non-digital advertising is that in order to access a network or a webpage, users have to perform complicated tasks, like typing out URLs in the web browser of their mobile device or computer. If they are accessing the web through a computer or a desktop device, there is also the problem of taking along the advertising materials containing the URLs to the computer terminal. This may be impossible in the case of display ads, posters or event advertising. Users may choose to take a mobile photograph of the advertisement and enter the URL once they are able to access their computer. However, the longer the time period between exposure to the advertisement and up-selling via a web page or application, the less likely the user is to follow through with the action—or even remember the advertisement. Thus, the known methods and system are overly complicated, cumbersome and downright difficult for some users. This also directly and adversely impacts the effect and measurability of non-digital advertisements.

Finally, a significant portion of advertising revenue involves national advertising by large companies that offer financial services, retail products, packaged goods, entertainment offerings, pharmaceuticals, automobiles and even political parties looking to promote their campaigns. These entities have very labor intensive requirements for advertising on local publications and corresponding local websites. For example, if a national advertiser wanted to conduct a local campaign, it would have to manually deal with every local newspaper for everything from advertising rates to advertising sizes, technical specifications or new section. There is no common or standard format, and every local newspaper may have different criteria and offerings for advertisement. With multiple format variations, it is common practice to display specific niche advertisements using own local rules and formats that allow customers to access webpages on the newspapers website.

In light of this, if a national advertising company wants to display its URLs on the web pages of ten different newspapers, the national advertising agent would have to contact each of these tenders separately and follow the process and parameters for placing their ad on a particular section or page. Since each newspaper would have a different technical and space requirement along with variable price points for each publication, not only with the agent have to negotiate ten different rates, but also each ad placement would have to be negotiated separately and then creative department would have to come up with ten different versions of the advertisement in order to successfully carry out the proposed campaign. Auditors would then be alerted to the URLs used on each paper section placing individual electronic and social orders as well as close monitoring of the analytics staff with specific instructions and follow-ups to each newspaper relevant department to ensure that optimum ROI is obtained from the entire exercise. In the end, most National advertisers today conclude that the cumbersome effort required to get their advertisements on local newspapers or websites is just not worth the return again and as a result, as common practice national advertisers currently tend to steer away from using local advertising publications. This is a significant loss of potential revenue for local and regional publications that, if remedied with a streamlined advertising sales process, could steer the non-digital advertising sphere towards more profit and efficiency.

The inability to measure the return on investment, advertising performance and real-time analytics to compete with digital advertising offerings and the cumbersome process for users to access advertising applications and web pages created by the advertiser, as well as the loss of revenue from failing to attract larger national advertising companies and businesses as a direct result of the tedious process involved publishing separately with local publications, has resulted in a shift away from the non-digital niche (both on the side of the end user as well as advertising clients and businesses). The reasons discussed above illustrate some of the reasons why marketers have steadily switched over to advertising primarily on digital platforms in recent years.

As a result, there is a need for a system and method that implements a streamlined, user-friendly and efficient system with an integrated online-offline advertising sales, monitoring and evaluation method for non-digital advertising. Furthermore, there is a need for a real-time system that would be able to process different types of advertisement campaigns, with different advertisers and types of advertisements (for example, billboards, newspapers, magazines, on-line, etc.), which are accessible for organization, planning, execution, monitoring and automated analytics through a computerized user interface.

There is also a need for a system and method that would reward users as an incentive for participation to increase interactivity and early-adoption. The present invention implements an interactive, direct-response system that allows advertisers the automated computerized system and facility for real-time observation of consumer interaction with advertising activities through the use of scanning Barcode, QR code, Image Recognition, Voice Recognition, Near Field Communication (NFC), Bluetooth Low Energy (BLE), using an interactive mobile application in combination with a network and an advertising database.

Whether it is physical or digital advertising spots (like AdSpots®), the present invention brings the entire media sales process online so the Advertisers and Marketers can discover advertising opportunities, connect with Media Owners and plan their entire advertising campaigns on a single platform. That means fewer emails, fewer phone calls, and a faster turnaround to execute more effective Return On Investment (ROI) driven campaigns.

In at least one embodiment, the present invention to provide a system and method for collecting advertisement information and for real-time analyzing, which has easy access to network, and is applicable to more kinds of media and inexpensive in cost. It is also important that it is able to record time information of sending and location information of a mobile terminal, to achieve the objective of being able to render real-time, dynamic and continuous analysis reports.

To achieve this objective, the present invention may utilize and implement a system for collecting advertisement information for real-time analysis and monitoring, which comprises an information carrier for carrying advertising information such as advertising media and advertisement-related content. The information carrier may use the encodable and automatically identifiable data such as barcode, QR code, Image Recognition, Voice Recognition, Near Field Communication (NFC), Bluetooth Low Energy (BLE) and other similar identifiable data.

The present invention may also include a digital electronic reading apparatus for reading the advertising information. The reading apparatus may be wirelessly connected to the mobile terminal, and the reading apparatus may be contained within any smart mobile device, such as a smartphone, tablet, laptop or any similar portable device with the ability to capture audio or visual information required to transmit the information carried within the information carrier.

The present invention may also include a database server and advertising apparatus for storing and sorting the advertising information, sales content, location and time information of the mobile terminal, as well as any other relevant and available demographic, behavioral or environmental information about the consumer.

The present invention may further include a network, connecting the mobile terminal and the advertising server, which may be private, public, wireless local area network or any similar transmitting format between the mobile terminal and the advertising server, which may be in the form of URL, email, SMS, MMS, WAP and other communication methodologies and protocols.

An analyzing apparatus of the present invention may be utilized for monitoring, measuring and evaluating Advertisement Performance Using Smart Devices, including performing statistical analysis on the consumer information collected. The analyzing apparatus may also be capable of sorting and conditionally combining collected advertising information and sending the results of the analytics to the advertiser terminal, as per advertiser request.

The present invention may also include a system and component for rewarding the consumer, to carry out desired actions configured by the advertisers, including, but not limited to downloading the mobile application, obtaining the virtual coupon ticket, filling out an advertising survey or questionnaire. The consumer may interact with the advertiser brand on social media platforms using methods such as “likes”, comments, subscriptions, follows or any other identified key performance indicators.

In accordance with another objective of the present invention, the consumer may interact with the advertiser or brand using virtual reality interactive applications, wherein the consumer interacts with their social network following and friends using follows, invites and recommendations to monitor their activities and drive engagement for the advertiser.

Another feature of the present system is to allow consumers share campaigns and consequently, earn more rewards including cash back, advertiser-specified discounts, brand promotion offers, rewards points and giveaways.

The present invention may be extensively utilized in real-time advertising performance analysis and dynamic market monitoring for out-of-home advertising, transit advertising, print advertising, radio advertising, television advertising, cinema advertising, event advertising, integrated digital advertising and any similar forms of advertising media.

The integrated and automated consumer reward system of the present invention fosters greater engagement, user adoption and interactivity. Due to the ability to implement computer and processor, executing computer instructions to track and log location, time and other consumer details within the present invention, advertising performance analysis becomes real-time, accurate and widely applicable across a variety of local, regional, national and even global advertising media. The flexibility of encoding large amounts of information within the information carrier also allows for a scalable, efficient method of compiling, sorting and classifying information according to different media, geographic locations, advertising content and consumer interaction and behavior, making the entire system comprehensive, scalable, rewarding and performance driven.

The present invention may also include a well-integrated, network-connected set of systems, servers and mobile devices to provide web and mobile applications for Advertisers, Media Sellers and Consumers to list, discover, plan, execute and analyze ROI driven campaign.

The present invention may also include ability for any business to list any media formats for brands to discover and book for local campaigns thereby converting their local foot traffic to their business to advertising sales.

The invention also provides ways for consumers to interact with brands and offerings in a very unique way of virtual reality, 3D modeling, facial recognition etc.

The present invention may include an automated computerized system or method for performing real time analysis of an advertisement campaign comprising: a mobile device having a display screen; at least one processor executing a plurality of computer instructions stored in memory, causing the processor to communicate with at least one computer server for: planning the advertisement campaign; executing the advertisement campaign monitoring and automatically analyzing the executing advertisement campaign; and tuning at least one executing campaign, wherein the advertisement campaign includes a plurality of advertisements in different media, comprising an online advertisement, a bar code in magazine, a bar code on a product and a product advertisement in social media.

In addition, the present invention may also include such features as a digital electronic reading apparatus for reading at least some of the plurality of advertisements in different media, or a database server and advertising apparatus having memory for storing and sorting the plurality of advertisements, and further storing a sales content, a location and a time information of at least one mobile terminal, and a demographic, behavioral and environmental information about at least one consumer.

The present invention may further implement a computerized user interface that allows to (a) define an objective, approach and creative strategy for the campaign; (b) determine areas of coverage for the campaign; (c) evaluate multiple media formats and options for the campaign; (d) establish a budget and performance criteria for the campaign; (e) send at least one request for proposal to a plurality of advertisers; and (f) iterate steps (a) to (e) to create a plan or the campaign.

The present invention may also implement a computerized user interface that (a) allows to electronically negotiate the rates and booking media assets; (b) finalizes a media plan; (c) activates at least one measurement method for measuring the user interactions, including a QR code, NFC or facial recognition; (d) specifies rewards and terms and conditions for spotting advertisement; and (e) shares the posting instructions for the campaign with other users.

The present invention may also implement a computerized user interface that (a) provides analytical tools for the campaign monitoring; (b) measures an overall data received for the campaign plan; (c) analyzes a performance dataset for each advertisement media format; and (d) analyzes a user demographics data comprising a user location, device type for the user, gender, age and visual impressions for the user.

The present invention may also implement a computerized user interface that (a) tunes the executing campaign and allows to change parameters based on a performance analysis and evaluation; (b) allows to change budget allocations for the executing campaign; and (c) measures and calculates the return on investment for the campaign.

The present invention may also implement a computerized user interface with a plurality of selectable tabs for planning, execution, monitoring, analysis and tuning of the campaign by a user.

The present invention may execute computer instructions that allow planning, execution, monitoring, analysis and tuning of offered rewards to consumers for a plurality of defined interactions with at least one brand, wherein the reward is based on (a) the user earning points for a campaign; (b) the user accumulating points that may be redeemed towards gifts and promotional offers; and (c) the user receiving a discount offered by an advertiser for a specific purchase.

The present invention may execute computer instructions that allow classifying and processing different types of consumer behavior comprising: (1) user sending a wireless request to advertiser and receiving a product information; (2) user scanning a barcode and completing a mandated action, and receiving a reward from an advertiser, upon verification of completion of the mandated action; (3) user submitting a proof of a brand interaction through social media contacts and receiving an advertiser discount; (4) user scheduling a transaction using a mobile device and receiving a product information for the scheduled transaction; and (5) user not initiating any transaction, and periodically receiving an advertisement campaign information that matches user interests, automatically identified based on user's preferences and social media activities.

The present inventio may further implement and use for its analysis and evaluation of the campaigns information related to (a) receiving and processing of user responses indicating a favorable view; (b) receiving and processing of user comments and activities on social media; and (c) receiving and processing of user subscriptions.

These and other beneficial features and advantages of the present invention are disclosed in detail hereinafter with reference to the accompanying drawings and description of various embodiments and features of the present invention.

### BRIEF DESCRIPTION OF THE DRAWINGS

FIG. 1 illustrates an overall organization and functioning of the performance analysis operations, starting with the acquiring advertisement content through the information carrier via a mobile device and terminating with the consumer reward and engagement matrix, in accordance with at least one embodiment of the present invention.

FIG. 2 is a depiction of processing and matching advertising IDs with advertisement information for real-time performance analysis, as well as data collection, sorting and classification, in accordance with at least one embodiment of the present invention.

FIG. 3 is a flow chart of matching consumer behavior patterns with advertising content, advertising data and consumer reward structure in accordance with at least one embodiment of the present invention.

FIG. 4 is a block diagram illustrating a comprehensive system and the interaction between the information carrier(s), mobile terminal apparatus, advertising server and advertiser terminal in accordance with at least one embodiment of the present invention.

FIG. 5 illustrates an overall interactions of various users with central cloud based advertising platform to create analytics driven Advertising Intelligence (AI) in accordance with at least one embodiment of the present invention.

FIG. 6 is a block diagram that depicts various process steps involved in executing an effective integrated campaign in accordance with at least one embodiment of the present invention.

FIG. 7 is a flow diagram that depicts organization of an integrated campaign process in accordance with at least one embodiment of the present invention.

FIG. 8A is a wireframe that depicts an interface for the advertiser media planning of an integrated automated real-time campaign in accordance with at least one embodiment of the present invention.

FIG. 8B is a wireframe that depicts an interface for launching an integrated automated real-time campaign in accordance with at least one embodiment of the present invention.

FIG. 8C is a wireframe that depicts an interface for the measurement of an automated real-time campaign performance in accordance with at least one embodiment of the present invention.

FIG. 8D is a wireframe that depicts an interface for performance analysis of a an automated real-time campaign performance in accordance with at least one embodiment of the present invention.

FIG. 8E is a wireframe that depicts an interface for user analysis of an automated real-time campaign performance in accordance with at least one embodiment of the present invention.

### DETAILED DESCRIPTION

One of the benefit of the present invention, advertisers, publications, businesses and the end-user can communicate and exchange data and information in real-time. In at least one embodiment, the present invention implements an automated computerized system, which is optimized for real-time efficient system for planning, scheduling and execution of integrated campaigns displaying, monitoring, data collection and analytics as well as classification of information and rewarding the consumer for participating in the media buying-selling process. The system may be implemented on a computerized network and is specifically adapted to online platforms and mobile devices using a mobile application.

Although particularly well-suited and optimized for use in online-offline integrated marketing and advertising campaigns, the present invention shall not be limited to a combined online-offline integration. Rather, the present invention is designed to be highly adaptable to incorporate digital, non-digital, online-offline integrated advertising campaigns or any combination thereof.

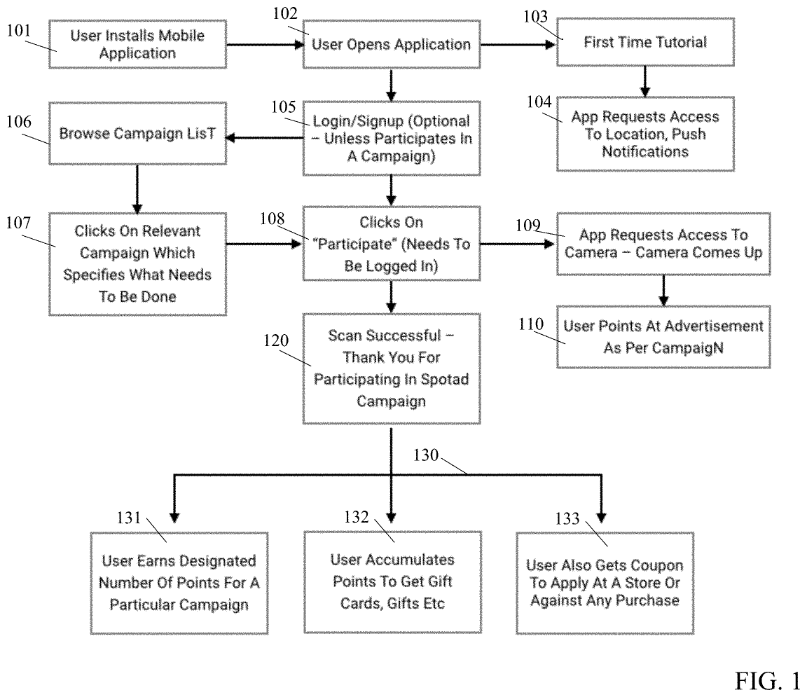

FIG. 1 illustrates an example of a consumer navigating the present invention in the form of a mobile application. As shown in FIG. 1, the user initiates the interaction by installing 101 the mobile application on the user mobile device, equipped with a processor, memory, display, photo and/or video camera and wireless transceiver, for receiving wireless communications. The user then opens 102 the application, and receives or requests a prompt for the first-time Tutorial 103, to guide the user through the application. As soon as it is open, the application request access to the location and permission 104 for push notifications through the mobile terminal.

When the user opens the application, there is also a prompt for login or signup 105. Both of these are completely optional, unless the user participates in the campaign. If the user chooses not to login or sign up, they can still opt to browse the campaign list 106. While browsing, the user may click on relevant campaigns 107, which causes the processor to execute computer instructions stored in computer memory, to allow the user to access specific information about what needs to be done to participate in that particular campaign.

In order to proceed, the user is required to login or signup 108. Only then the user is allowed to click on or select the participate button 110, presented to him or her on the application interface. If a visual information input is required to proceed, the app will request 109 access to the camera. The user will have to approve this request and the camera will come up. Then, the user focuses 110 the camera at the advertisement, as per campaign directions.

If visual information input is not required, the end user may be asked to perform voice recognition, connect through near field communication, or Bluetooth low energy.

Regardless of the type of input required, once the scanning criteria are met, the user may receive 120 a prompt on a display screen, stating “Scan successful—Thank you for participating in SpotAd Campaign”. It may show up on the screen, indicating that the user is eligible to check if they have earned a reward as a result of their participation.

Once the user has participated successfully in a SpotAd campaign, the system generates an advertiser specified reward 130. The reward may include (but is not limited to): (1) the user earning a designated number of points for a particular campaign 131; (2) the user accumulating points to redeem towards gift cards, gifts, promotional offers or giveaways 132; or the user getting a coupon or an advertiser-specified discount to apply at a store or against any purchase specified by the advertiser 133. Other types of rewards are contemplated and included as part of the present invention.

The automated real-time campaign organization, management and analysis system that is described in this specification is implemented by a computer processor or processors, executing specific computer instructions stored in computer memory, wherein execution of the computer instructions causes the system to function in a manner that allows the automated real-time system of the present inventio to operate, and also provides a user interface to the planning, execution, monitoring and analysis of the advertisement campaign. The implementation of the specialized computer code is not limited to any particular programming language and could be implemented based on the description of the desired functionality and interaction with other system components by a number of different computer languages, including JAVA, XML and many others.

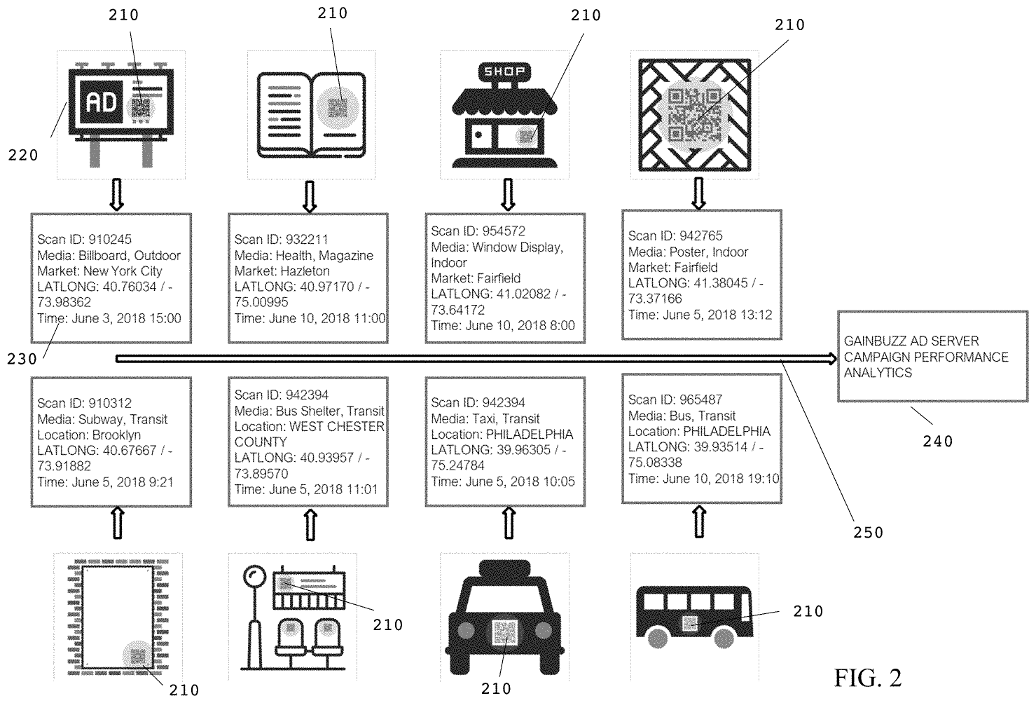

FIG. 2 illustrates examples of different data subsets being generated, bot analytics and campaign targeting using QR code technology and various advertising media such as radio, print, outdoor displays, event advertising and other similar advertising media channels.

Referring to FIG. 2, in at least one embodiment, the present invention involves the use of an advertising barcode or QR code or id 210, which has been encoded into the corresponding advertising ID. Looking at the example of advertising QR code from an outdoor billboard 220, this code would be encoded into the advertising ID with the serial number 910245. There is also a reading time 230 attached to the advertising ID, which specifies the date and time of the interaction. In this example, the reading time would be 15:00 hours, and the record date would be Jun. 10, 2018, 2018.

The advertising ID, its corresponding barcode as well as the reading time is sent to the advertising terminal from the mobile terminal apparatus via the network 250. It is then forwarded to the advertising server 240 and an advertising data subset is analyzed and stored in the advertising server according to the matched advertising ID, so the entire dataset reads as such: “Advertiser: Levi's, Advertisement title: Denim Jacket, Media: Billboard, Outdoor, Region: New York City, N.Y., Reading date: 2017, Jun. 3, Reading time: 1500 hrs”.

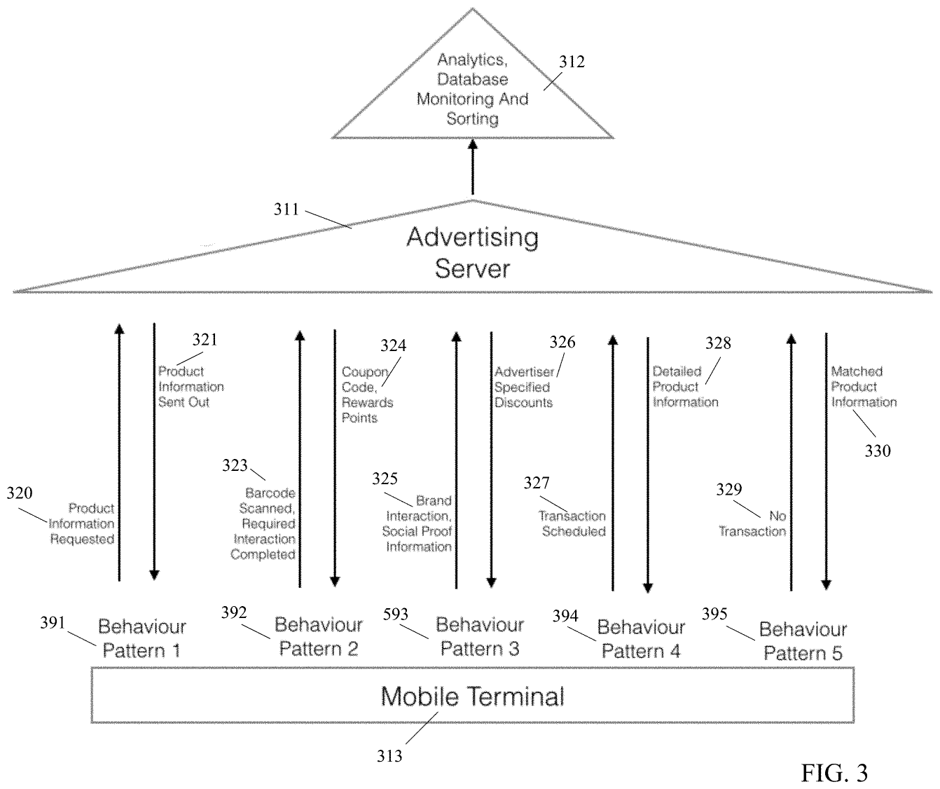

FIG. 3 illustrates schematic diagram for classifying consumer behavior based on the received data and creating a feedback loop between the advertising server 311 and the mobile terminal 313.

The embodiment and features of the present invention shown in FIG. 3, classifies consumer behavior into five common potential patterns, shown as behavioral patterns 391-395, respectively. The consumer requests 320 product information 321 using the mobile terminal apparatus 313, sending a wireless request to the advertising server via a network (ex. Internet, LAN or WAN). The advertising server 311 responds by sending out product information 321 to the mobile terminal apparatus 313 via the network.

In the behavior pattern 2, shown as 392 in FIG. 3, the consumer scans the barcode as per campaign requirements 323, and the consumer completes the mandated actions in order to receive advertiser specified rewards 324. This information is transmitted via the network to the advertising server, and the server responds back with the appropriate coupon code, your words points, advertiser specify discounts, promotional offers, giveaways as appropriate.

The behavior pattern 3, shown as 393 in FIG. 3, illustrates an embodiment and a feature of the present invention, where the system is utilized for the integrated and targeted social campaigns. The user sends out social proof of brand interaction 325 in the form of likes, follows, commenting or any other advertiser-specified actions in order to meet the criteria for a particular reward. The proof of interaction maybe in the form of a screenshot, URL, a link to social platform activity, shared tweet or other social sharing activity. This information is carried to the advertising server via the network and the server responds with appropriate advertiser-specified discounts 326, which are sent back to the mobile terminal.

In the behavior pattern 4, shown as 394 in FIG. 3, the user schedules a transaction 327 using the mobile terminal which is transmitted over the network to the advertising server which in tum response with detailed product information 328 in order to help the user make a purchasing decision.

In the behavior pattern 5, shown as 395 in FIG. 3, the user does not make any transaction 329. However, the mobile terminal records and sends information about the consumer showing an interest in a particular campaign via the use of technology such as scrolling or heat maps. This information is recorded and sent to the advertising server, which is then cued by the advertiser to send the user periodic product information 330, matched to the user's interests, so that when the user is primed to make a purchase or to interact with the campaign, they have all the required information.

All of these recorded behavior patterns, as well as those not highlighted in FIG. 3, are compiled and stored 312 with the advertising server for analytics, database monitoring and segmentation, in order to help with future campaign targeting and strategy. The actual recorded data can be stored in a database.

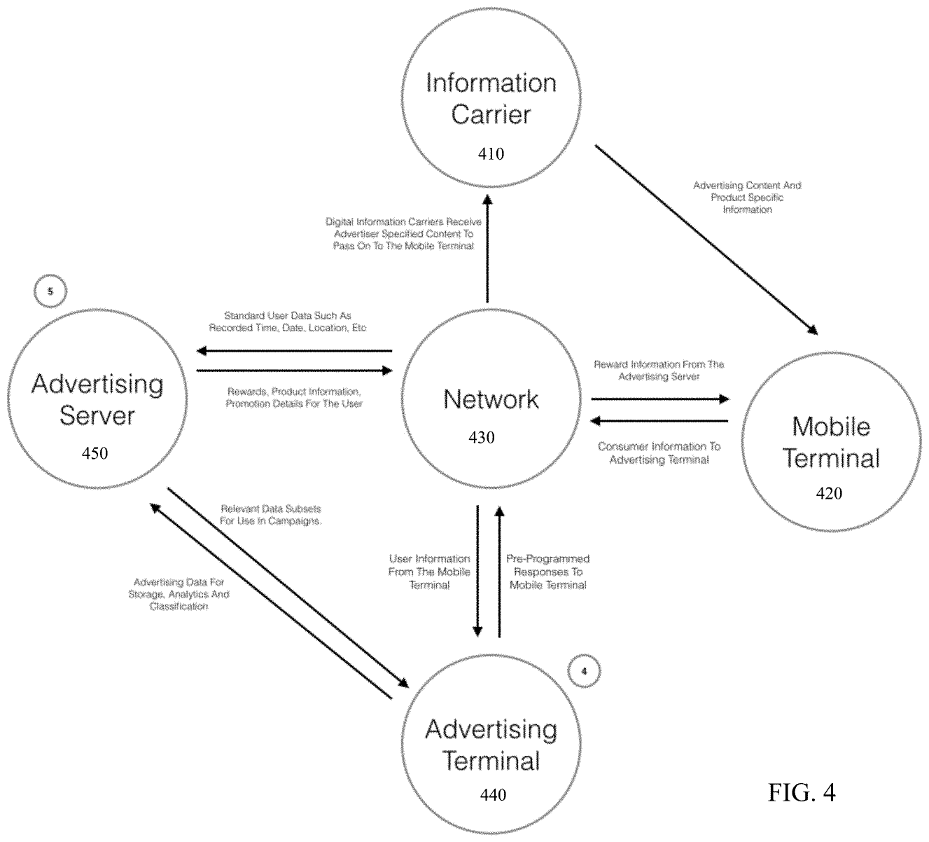

FIG. 4 illustrates a comprehensive matrix for the present invention, as well as the interaction between the information carrier(s), mobile terminal apparatus, advertising server and advertiser terminal in accordance with at least one embodiment.

In the embodiment of the invention shown in FIG. 4, the Information carrier 410 receives information via the network 430 from the advertising server 450, and the advertising terminal 440, operated by an advertising professional that can be passed on to the consumer via the mobile terminal 420.

In the case of digital information carriers; barcodes, QR code, Image Recognition, Voice Recognition, Near Field Communication (NFC), Bluetooth Low Energy (BLE) transmission of information carrier data, the advertising terminal transmits advertising content and information to the information carrier.

The information carrier encoded with advertising information transmits advertising content, advertiser specified information as well as the requirements for interaction using a barcode, QR code, Image Recognition, Voice Recognition, Near Field Communication (NFC) or Bluetooth Low Energy (BLE) to the mobile terminal operated by the consumer. The mobile terminal 420 then sends out proof of the user completing intended actions, as well as specific consumer information to the advertising terminal 440 via the network 430.

The user information sent from the mobile terminal 420 is captured by the advertising terminal 440 before being sent to the advertising server 450. The advertising terminal may also carry a number of pre-programmed responses for real-time interaction with the mobile terminal, especially in the case of users requesting additional information. These responses are sent via the mobile network to the mobile terminal 420.

At the other end, the advertising data is sent from the advertising terminal 440 to the advertising server 450 for storage, analytics and classification. At the advertising server 450, relevant data subsets are sent to advertisers via the advertising terminal for use in various advertising campaigns.

The advertising server 450 also receives standard user data such as recorded time, date, location, distribution media type, advertising ID which are transmitted to the server for storage and classification into targeted advertising data subsets for the server's advertising database. The advertising server 450 processes all the relevant data and relevant data is also sent to the to the end user via the network to the mobile terminal e.g. rewards, product information, promotion details.

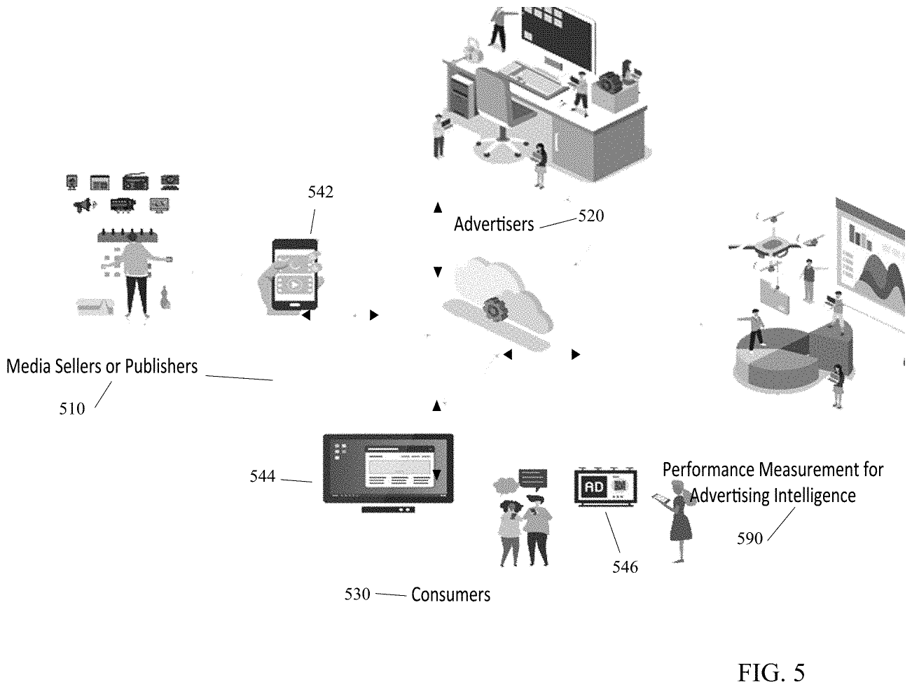

FIG. 5 illustrates how different users interact with centralized cloud based for planning, execution and monitoring of the integrated campaigns across various media formats. FIG. 5 illustrates Media Sellers or Publishers 510, Advertisers 520 and consumers 530 interacting with a centralized cloud based server for planning execution, monitoring and performance measurement 590 for Advertising Intelligence, which is provided to different types of users. The communication is performed in real-time thought a mobile device 542, a desktop 544 or a scanner or a device equipped with a scanner 546. Performance can be measured on real-time basis to tune advertising investments in different channels to achieve better ROI driven result.

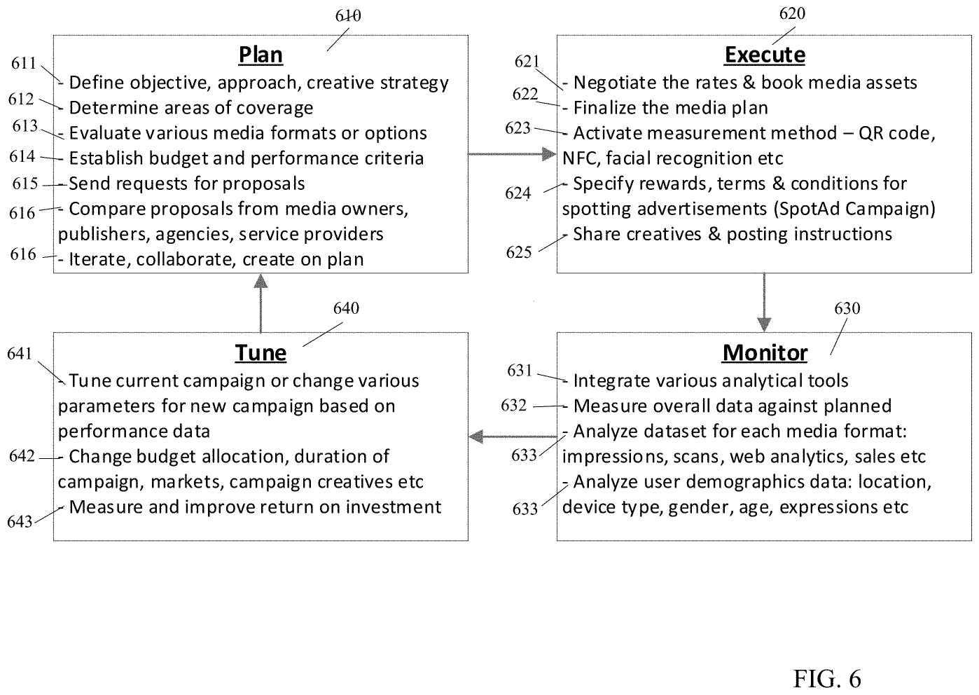

FIG. 6 illustrates various process steps involved in planning, executing, monitoring and tuning of the effective campaign in accordance with at least one embodiment. The process for more efficient real-time system may include the following key steps: (a) Planning 610, (b) Execution 620, (c) Monitoring 630, and then (d) Tuning 640. After the completion of the steps, the system and method may be iterated, going back to Planning 610 stage, with more insight and better plan.

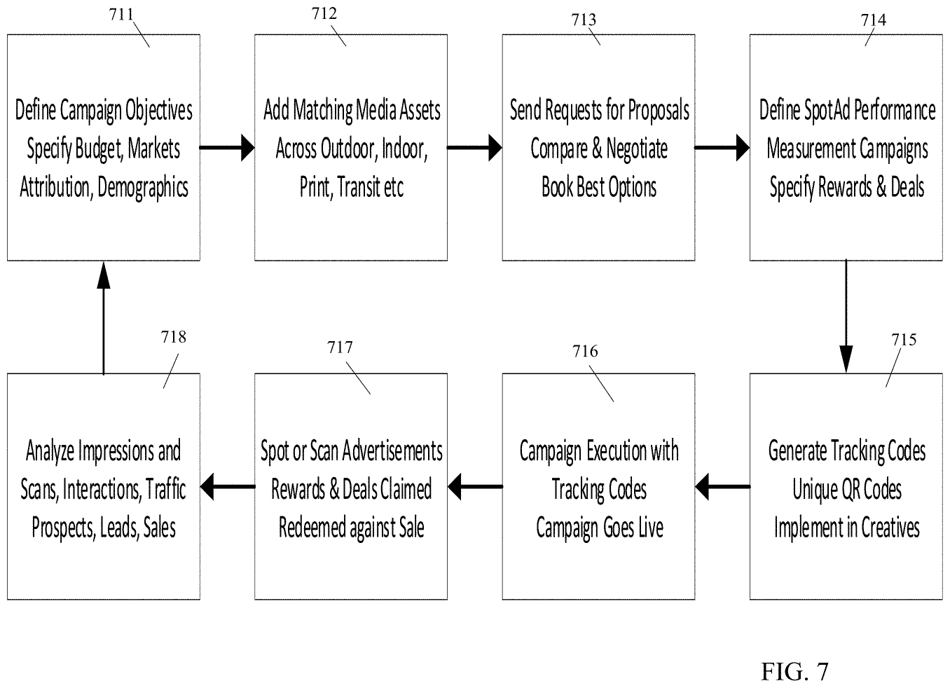

FIG. 7 depicts the same key process steps involved, and which can be achieved and implemented in accordance with at least one embodiment, using various web and mobile app features connected to central cloud-based system.

As illustrated in FIG. 6, the Planning 610 stage may involve at least some of the steps and actions that may be implemented trough a user interface in accordance with at least one embodiment. The steps include at least some of the following: (1) defining objective, approach and creative strategy, 611; (2) determining areas of coverage 612; (3) evaluating various media formats and options 613; (4) establishing budget and performance criteria 614; (5) sending RFPs 616; and (6) iterate, collaborate and create a plan 617.

The Execution 620 may involve at least some of the following steps and actions, preferably implemented through a user interface: (1) negotiating the rates and booking media assets 621; (2) finalizing a media plan 622; (3) activating measurement method—such as, for example, QR code, NFC or facial recognition 623; (4) specifying rewards, terms and conditions for spotting advertisements (ex. SpotAd Campaign) 624; and (5) sharing the creative & posting instructions 625.

The Monitoring 630 may involve at least some of the following steps and actions, preferably implemented through a user interface: (1) integrating various analytical tools 631; (2) measuring 632 overall data received against plans; (3) analyzing performance datasets 633 for each media format, such as impressions, scans, web analytics and sales; and (4) analyzing user demographics data, 634 location, device type used by the user, gender, age and visual impressions from the user.

Finally, the Tuning 640 may involve at least some of the following steps and actions, preferably implemented through a user interface: (1) tune current campaign or change parameters for new campaign based on performance analytics data 641; (2) changing budget allocations, altering duration of campaign; and (3) measure and improve return on investment 643.

FIG. 7 depicts similar process steps that may be streamlined and processed in real time in accordance with at least one embodiment. These steps can be achieved using various web and mobile app features connected to central cloud-based system. First, at the Planning stage, the system includes defining campaign objectives, specifying budget, markets, attribution and demographics 711 for the intended campaign.

Subsequently, at 712, the user and system may add matching media assets across outdoor or indoor advertisers, print, transit, etc. Once the matching media assets are identified and determined, the computerized system may automatically generate and send Requests for Proposal (RFPs), compare and negotiate, and book or select best options at 713.

At 714, the system may define the campaign (ex. SpotAd) performance and monitor the campaign. It may also specify and assign rewards and deals. At 715, the system may automatically generate tracking codes, assign unique QR codes and other tracing and identification schemes. Subsequently, at 716, the advertising campaign may start the Execution phase or operation, with set tracking codes and strategy and campaign evaluation methodology defined for the automated analytics.

At 717, the spot or scan advertisements are monitored and evaluated. It may also account for and evaluate claimed rewards and deals, which may be redeemed against the sale or some other action that automatically triggers the release of a reward.

At 718, the server performs automated processing in real-time, for analyzing the impressions and scans in the advertisement campaign, evaluating interactions, traffic, prospects, leads, sales and other defined metrics for the automated real-time analysis of the campaign performance and meeting of the set defined goals. This is done for multiple different advertising media assets through the common user interface. The output of the analysis may also be automatically processed by another campaign (iteratively).

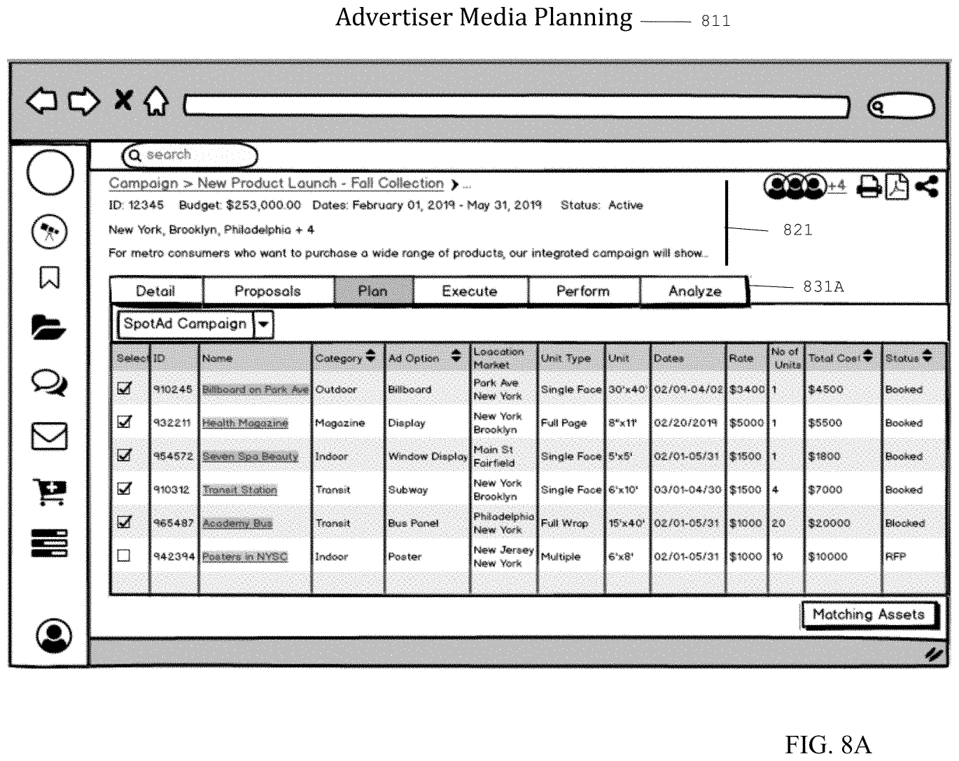

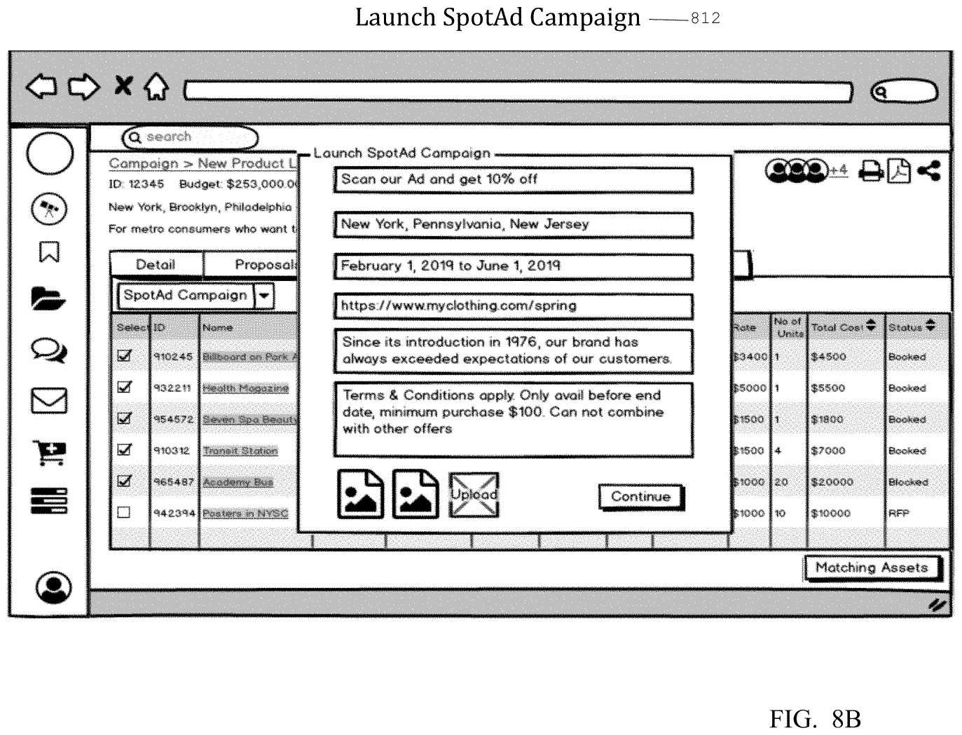

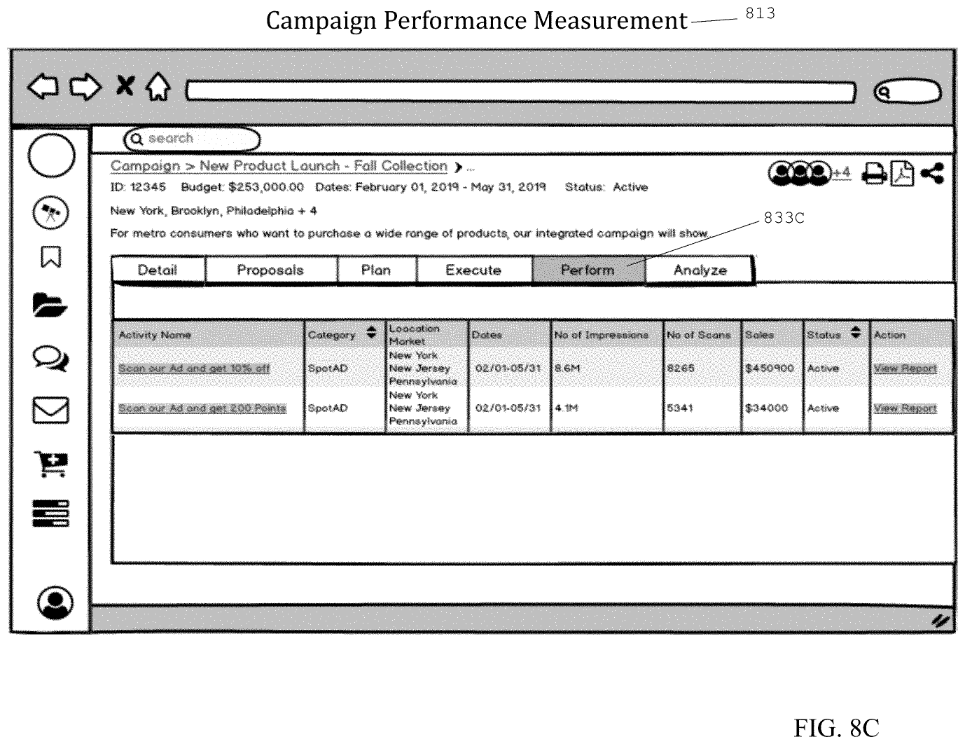

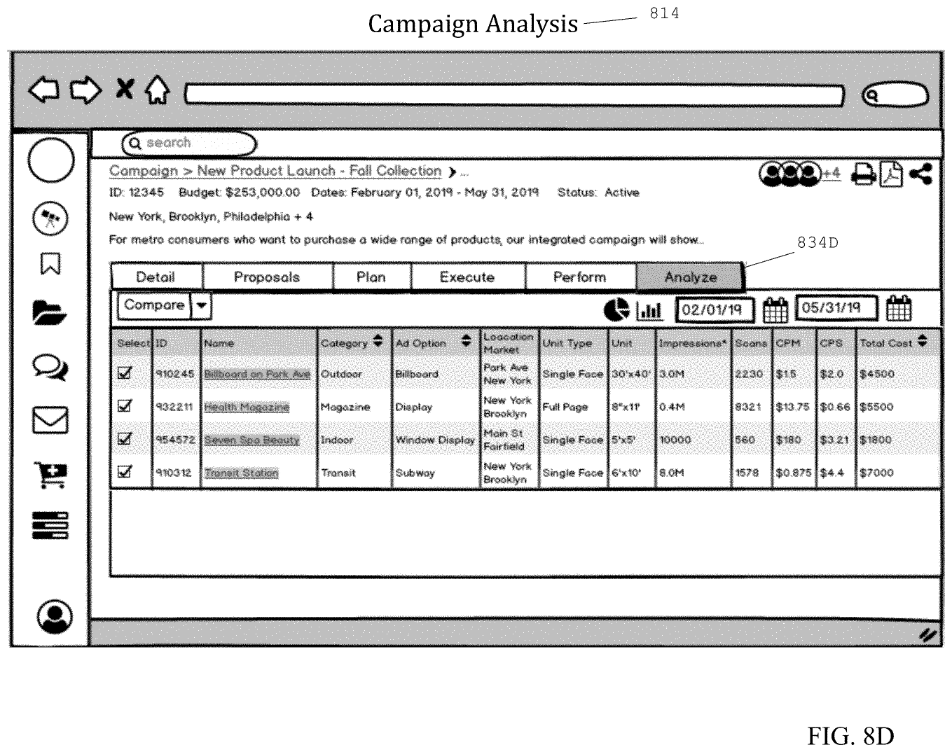

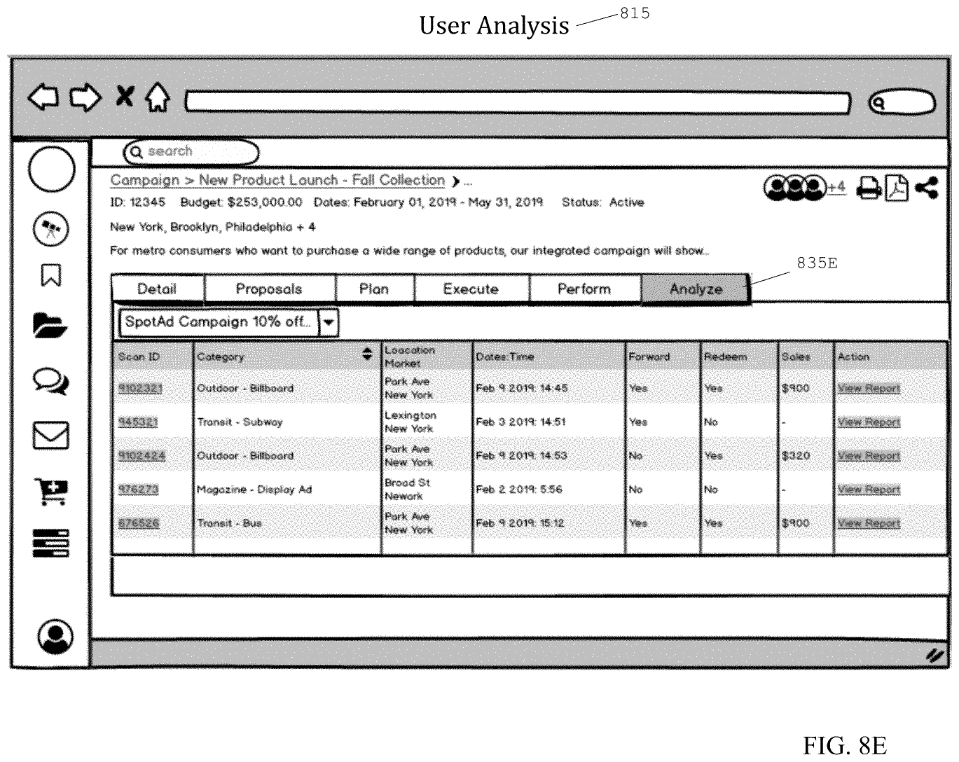

FIG. 8A is a wireframe that depicts an interface for the advertiser media planning 811 of an integrated automated real-time campaign in accordance with at least one embodiment of the present invention. FIG. 8A illustrates how advertisers can add various media assets through a common user interface, to plan and launch SpotAd performance measurement campaign across those advertising assets in accordance with at least one embodiment. The campaign related information, such as ID, budget, address, date, status and a short description 821 are shown on screen. Also, the action tabs may include a selectable action for planning, execution, monitoring and analysis of the campaign. The planning action can be selected by clicking or choosing the 4 Plan action tab 831A

FIG. 8B is a wireframe that depicts an interface for launching 812 an integrated automated real-time campaign in accordance with at least one embodiment of the present invention. FIG. 8B shows how SpotAd performance measurement campaign 812 can be configured to entice and allow the end consumer to spot or scan an advertisement. As shown in FIG. 8B, the user can define different actions and incentives through a common user interface. For example, the campaign strategy organizer may define where the campaign originates, where it is available, the validity dates and actions that may be performed after a scan of a campaign is performed. It could direct the participant to open a webpage, receive rewards, set-up and indicate the reward type (or percentage). For fashion and other advertisement campaigns, it could provide a 3D model, a video, a survey or direct the participant to an online store.

FIG. 8C is a wireframe that depicts an interface for the measurement 813 of an automated real-time campaign performance in accordance with at least one embodiment of the present invention. The user may select the Perform tab 833C to select, set-up, examine or modify the campaign performance data. FIG. 8C shows different performance campaigns and their overall performance.

The user interface shown in FIG. 8C allows users to perform comparison between different campaigns based on specific factors or conditions that are selected by user or set as qualifiers or parameters for the campaign success analysis (ex. rewards, impressions). Parameters for determining the success of a campaign may also include comments from the end users or third parties, ratings, reviews, shares with others in social media, or some other specified social media interactions after received the advertisement.

FIG. 8D is a wireframe that depicts an interface for performance analysis 814 of a an automated real-time campaign performance in accordance with at least one embodiment of the present invention. The user may select the Analyze tab 834D to select, analyze the campaign performance data. FIG. 8D illustrates analysis across various channels and formats of advertising and their performance based on the set criteria for the campaign. The advertisement campaign criteria used for analysis may include the location market information, impressions, scans, CPM and CPS (cost per scan) for the advertising campaign, as indicated in FIG. 8D.

FIG. 8E is a wireframe that depicts an interface for user analysis 815 of an automated real-time campaign performance in accordance with at least one embodiment of the present invention. The user analysis may be selectable through selecting the Analyze tab 835D to analyze the user campaign data. FIG. 8E illustrates detailed user analysis showing various actual actions performed by the user. It may include information indicating where certain user actions or interactions with the campaign took place, cost, date, and what other actions took place after the interaction with the advertising campaign. Based on this user analysis, the campaign system of at least one invention can determined (automatically and through user selection) whether to send notifications to the user. For example, if the user did not receive the product information, a notice that such notification option is available can be sent. As illustrated in FIG. 8E, the operator may toggle between different advertisement campaigns and review actual actions taken by each user (or consumer), as well as perform analysis and comparison of different campaigns.

### Application Architecutre

The present invention is a performance-based consumer mobile application, that can be implemented on a mobile telephone or other mobile device, equipped with a processor, memory, display, camera and including a transceiver for wireless communications through a network and/or Internet. It allows advertisers to create instant engagement, collect relevant data and measure advertising performance using a cost-effective, high-engagement and real-time interactive mechanism.

The advertiser designs a customized campaign to meet specific marketing needs using various planning, communication, execution and performance features of the web and mobile applications connected with cloud based advertising server. Then, the advertiser publishes the campaign via a network to the advertisement planning and buying server. The advertising server simultaneously collects information from both advertisers and consumers. Once relevant information is logged in the server's database, the server is also equipped to send out an advertising options and analysis report, which can be accessed by the advertiser to craft a customized campaign over a variety of media networks, and incorporates a multitude of media types including outdoor, digital, transit, event displays, transit, radio, television, print and mailers to name a few.

The advertiser uses information and analysis from the server to craft a unique campaign for each media type. The mobile application in the present invention offers a system for using mobile devices for scanning codes, image, voice recognition, near-field communication and so on. As a result, consumers are able to spot and scan ads across a variety of media types including but not limited to print, outdoor, ambient, transit, events and cinema advertising.

Once the campaign runs for the intended period of time and simultaneously, the advertiser is able to obtain advertising performance and consumer information in order to make real-time, agile decisions about their marketing strategy.

The above embodiments and illustrative descriptions of the application of the principles of the present invention are intended to enable a person skilled in the art to make or use the disclosed invention. They are not intended to be either exclusive, exhaustive or limiting on the scope of the invention described and claimed herein.

Other variations or modification could be used and applied by a person skilled in the art without deviating from the scope and spirit of the present invention. Such modifications and alternatives arrangements are not intended invention to be outside the scope of the present invention and are intended to be covered by it. The invention title and abstract are not intended to limit the claimed invention or cover multiple embodiment and all various features of the claimed invention.

I hereby claim:

1. An automated computerized system for performing real time analysis of an advertisement campaign comprising:
a mobile device having a display screen;
at least one processor executing a plurality of computer instructions stored in memory, causing the processor to communicate with at least one computer server for:
planning the advertisement campaign;
executing the advertisement campaign
monitoring and automatically analyzing the executing advertisement campaign; and
tuning at least one executing campaign,
wherein the advertisement campaign includes a plurality of advertisements in different media, comprising an online advertisement, a bar code in magazine, a bar code on a product and a product advertisement in social media.

2. A system of claim 1, further including a digital electronic reading apparatus for reading at least some of the plurality of advertisements in different media.

3. A system of claim 1, further including a database server and advertising apparatus having memory for storing and sorting the plurality of advertisements, and further storing a sales content, a location and a time information of at least one mobile terminal, and a demographic, behavioral and environmental information about at least one consumer.

4. A system of claim 1, wherein the processor executing computer instructions for planning the advertisement campaign implements a user interface that
(a) defines an objective, approach and creative strategy for the campaign;
(b) determines areas of coverage for the campaign;
(c) evaluates multiple media formats and options for the campaign;
(d) establishes a budget and performance criteria for the campaign;
(e) sends at least one request for proposal to a plurality of advertisers; and
(f) iterate steps (a) to (e) to create a plan or the campaign.

5. A system of claim 1, wherein the processor executing computer instructions for executing the advertisement campaign implements a user interface that
(a) allows to electronically negotiate the rates and booking media assets;
(b) finalizes a media plan;
(c) activates at lest one measurement method for measuring the user interactions, including a QR code, NFC or facial recognition;
(d) specifies rewards and terms and conditions for spotting advertisement; and
(e) shares the posting instructions for the campaign with other users.

6. A system of claim 1, wherein the processor executing computer instructions for monitoring and analyzing the executing advertisement campaign implements a user interface that
(a) provides analytical tools for the campaign monitoring;
(b) measures an overall data received for the campaign plan;
(c) analyzes a performance dataset for each advertisement media format; and
(d) analyzes a user demographics data comprising a user location, device type for the user, gender, age and visual impressions for the user.

7. A system of claim 1, wherein the processor executing computer instructions for tuning the executing advertisement campaign implements a user interface that
(a) tunes the executing campaign and allows to change parameters based on a performance analysis and evaluation;
(b) allows to change budge allocations for the executing campaign; and
(c) measures and calculates the return on investment for the campaign.

8. A system of claim 1, wherein the processor executing computer instructions implements a user interface with a plurality of selectable tabs for planning, execution, monitoring, analysis and tuning of the campaign by a user.

9. A system of claim 1, further configured to execute computer instructions that allow planning, execution, monitoring, analysis and tuning of offered rewards to consumers for a plurality of defined interactions with at least one brand, wherein the reward is based on (a) the user earning points for a campaign; (b) the user accumulating points that may be redeemed towards gifts and promotional offers; and (c) the user receiving a discount offered by an advertiser for a specific purchase.

10. A system of claim 1, further configured to execute computer instructions that allow classifying and processing different types of consumer behavior comprising:
(1) user sending a wireless request to advertiser and receiving a product information;
(2) user scanning a barcode and completing a mandated action, and receiving a reward from an advertiser, upon verification of completion of the mandated action.
(3) user submitting a proof of a brand interaction through social media contacts and receiving an advertiser discount;
(4) user scheduling a transaction using a mobile device and receiving a product information for the scheduled transaction;
(5) user not initiating any transaction, and periodically receiving an advertisement campaign information that matches user interests, automatically identified based on user's preferences and social media activities.

11. A method for performing automated real time analysis of an advertisement campaign comprising the steps of:
planning the advertisement campaign;
executing the advertisement campaign
monitoring and automatically analyzing the executing advertisement campaign; and
tuning at least one executing campaign, wherein the advertisement campaign includes a plurality of advertisements in different media, comprising an online advertisement, a bar code in magazine, a bar code on a product and a product advertisement in social media.

12. A method of claim 11, further including reading at least some of the plurality of advertisements in different media, said reading preformed by a digital electronic reading apparatus.

13. A method of claim 11, further comprising storing in a database a sales content, a location and a time information of at least one mobile terminal, and a demographic, behavioral and environmental information about at least one consumer.

14. A method of claim 11, wherein the step of planning the advertisement campaign is performed through a user interface that
(a) defines an objective, approach and creative strategy for the campaign;
(b) determines areas of coverage for the campaign;
(c) evaluates multiple media formats and options for the campaign;
(d) establishes a budget and performance criteria for the campaign;
(e) sends at least one request for proposal to a plurality of advertisers; and
(f) iterate steps (a) to (e) to create a plan or the campaign.

15. A method of claim 11, wherein the step of executing the advertisement campaign is performed through a user interface that
(a) allows to electronically negotiate the rates and booking media assets;
(b) finalizes a media plan;
(c) activates at lest one measurement method for measuring the user interactions, including a QR code, NFC or facial recognition;
(d) specifies rewards and terms and conditions for spotting advertisement; and
(e) shares the posting instructions for the campaign with other users.

16. A method of claim 11, wherein the step of monitoring and analyzing the advertisement campaign is performed through a user interface that
(a) provides analytical tools for the campaign monitoring;
(b) measures an overall data received for the campaign plan;
(c) analyzes a performance dataset for each advertisement media format; and
(d) analyzes a user demographics data comprising a user location, device type for the user, gender, age and visual impressions for the user.

17. A method of claim 11, wherein the step of tuning the advertisement campaign is performed through a user interface that
(a) tunes the executing campaign and allows to change parameters based on a performance analysis and evaluation;
(b) allows to change budget allocations for the executing campaign; and
(c) measures and calculates the return on investment for the campaign.

18. A method of claim 11, further comprising the steps of offering a reward to consumers for a plurality of defined interactions with at least one brand, wherein the reward is based on (a) the user earning points for a campaign; (b) the user accumulating points that may be redeemed towards gifts and promotional offers; and (c) the user receiving a discount offered by an advertiser for a specific purchase.

19. A method of claim 11, further comprising the steps of:
(a) receiving and processing of user responses indicating a favorable view;
(b) receiving and processing of user comments and activities on social media; and
(c) receiving and processing of user subscriptions.

20. A method of claim 11, further comprising the step of classifying different types of consumer behavior comprising:
(1) user sending a wireless request to advertiser and receiving a product information;
(2) user scanning a barcode and completing a mandated action, and receiving a reward from an advertiser, upon verification of completion of the mandated action;
(3) user submitting a proof of a brand interaction through social media contacts and receiving an advertiser discount;
(4) user scheduling a transaction using a mobile device and receiving a product information for the scheduled transaction; and
(5) user not initiating any transaction, and periodically receiving an advertisement campaign information that matches user interests, automatically identified based on user's preferences and social media activities.
